(19) United States
(12) Patent Application Publication
(10) Pub. No.: US 2021/0285790 A1
(43) Pub. Date: Sep. 16, 2021

(54) System and Method for Assigning a Unique Identification to an Address and Optimizing the Same

(71) Applicant: Delhivery Private Limited, Gurgaon (IN)

(72) Inventors: Kabir Rustogi, New Delhi (IN); Rahul Kumar, Gurgaon (IN); Anshu Aditya, Bhagalpur (IN)

(73) Assignee: Delhivery Private Limited, Gurgaon (IN)

(21) Appl. No.: 17/064,686

(22) Filed: Oct. 7, 2020

(30) Foreign Application Priority Data
Mar. 16, 2020 (IN) 202011011137

(51) Int. Cl. G01C 21/00; G06N 20/00

(52) U.S. Cl. CPC G01C 21/3811; G01C 21/3841; G06N 20/00

(57) ABSTRACT

Disclosures in the present invention relate to a system and method of generating and optimising unique address parameters for entities described by addresses and locations. The system in the present invention stores multiple addresses mapped with their estimated physical locations in a database. A first address is parsed and broken down into at least nationality, state, city, town, locality, sub-locality, street, landmark, building, floor number, identification number, postal code, zip code or any other address identifying parameter. Similar addresses are searched for in the list of stored addresses and their addresses and locations are matched with the address and location of the first address to generate a unique address parameter. Multiple addresses with a high level of proximity may be mapped onto the same unique address parameter, in order to keep the database optimized.

### CROSS-REFERENCE TO RELATED APPLICATIONS

This non-provisional patent applications claims the benefit of and priority to Indian Patent Application Serial No. 202011011137, filed Mar. 16, 2020, entitled “System and Method for Assigning a Unique Identification to an Address and Optimizing the Same,” the entire contents of which is hereby incorporated herein by reference.

### FIELD OF INVENTION

Embodiments of the disclosure relate generally to the field of machine learning and data interpretation. More particularly, embodiments of the disclosure relate to a system, method and system for generating and assigning unique identification to an address and optimizing the same.

### BACKGROUND

Most of the earth's population has a poorly defined addressing system, thus having a poorly discoverable residence, property or business locations on a map. Delivery service providers, including mail delivery providers, are faced with certain challenges in situations where the discoverability of an address is an issue. Misdirected mail is a source of inefficiency to the entity sending the mail. Likewise the time and resources expended by the entity handling the mail also represent lost resources. Delivery service providers handles millions of mailpiece items in a calendar year, and the inefficiency and waste associated with misdirected mail carries significant costs.

In poorly defined and unstructured addressing systems, consumers and other participants independently identify and adopt addressing schemes according to their own convenience. Much of the addresses are written with respect to a landmark which typically lies between 50-1500 meters of the actual address location. Weakly defined or haphazardly defined postal code schemes only add to the inconvenience.

Such addressing schemes allow a significant amount of noise to creep into written addresses. Automated systems or computer assisted systems find it difficult to decode this noise and to resolve the addresses with reasonable accuracy. Differently written versions of a single address may be resolved miles apart from each other. Similarly, two different addresses, when poorly described, may cause the automated system to resolve both to a same location.

A need, therefore, arises for a method and system to determine uniqueness of written addresses among each other.

### BRIEF DESCRIPTION OF THE DRAWINGS

Embodiments according to the claimed subject matter are described below with reference to the drawings. The detailed description references the accompanying figures. The same numbers can be used throughout the drawings to reference like features and components. As used herein, like terms refer to like elements throughout the description. It should be noted that views of exemplary embodiments are merely to illustrate selected features of the embodiment. The views qualitatively illustrate exemplary features of some embodiments and, therefore, should not be interpreted as being drawn to scale.

FIG. 1 is a block diagram schematically showing a system according to some embodiments of the present invention.

FIG. 2 illustrates a data storage module according to some embodiments of the present invention.

FIG. 3 illustrates a directed acyclic graph corresponding to address data stored in the data storage module according to some embodiments of the present invention.

FIG. 4 illustrates a unique identification generation system, according to one embodiment of the present invention.

FIG. 5 illustrates a unique identification optimization system, according to one embodiment of the present invention.

### SUMMARY

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

It is an object of the invention to provide improved methods for generating a unique identification for an address of an entity.

It is another object of the invention to provide improved methods for optimizing a database containing unique identifications for a plurality of addresses of a plurality of entities.

According to one aspect of the present invention, there is disclosed a computer system including one or more processing modules. The computer system further comprises one or more data storage modules operably coupled to the one or more processing modules. The computer system also comprises at least one memory module coupled to the one or more processing modules. The processing modules may be configured to select a first address data corresponding to an address of a first entity and a second address data corresponding to an address of a second entity; compute a first correlation between the first address data and the second address data; compute a second correlation between a location data of the first entity and a location data of the second entity; and update the location data corresponding to a location of the first entity.

The independent claims define the invention in various aspects. The dependent claims state selected elements of embodiments according to the invention in various aspects.

This summary is submitted with the understanding that it will not be used to interpret or limit the scope or meaning of the claims. This summary is not intended to identify key features or essential features of the claimed subject matter, nor is it intended to be used as an aid in determining the scope of the claimed subject matter. Other methods, apparatus and systems are also disclosed. Those skilled in the art will recognise additional features and advantages upon reading the following detailed description, and upon viewing the accompanying drawings.

### DETAILED DESCRIPTION

For purposes of explanation, numerous specific details are set forth in order to provide a thorough understanding of the claimed subject matter. It may be evident, however, that the claimed subject matter may be practiced without these specific details. Also, in some instances, well-known features are omitted or simplified to clarify the description of the exemplary implementations. In some other instances, well-known features or units or circuits have been shown in block diagram form in order avoid clutter due to unnecessary detailing. Reference will now be made to the drawings to describe the present invention in detail. The implementations herein are described in terms of exemplary embodiments. However, it should be appreciated that individual aspects of the implementations may be separately claimed and one or more of the features of the various embodiments may be combined.

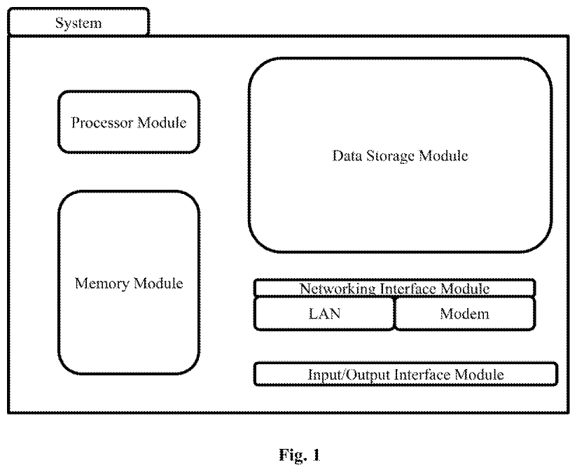

FIG. 1 is a block diagram schematically showing a system according to some embodiments of the present invention. As shown, the system may comprise at least one processing module, one or more data storage modules coupled to the one or more processing module and at least one memory module coupled to the one or more processing modules. The system may further include a networking interface, to allow the system to operate in a networked environment supporting connections to one or more remote computers, such as mobile devices and computing devices. The networking interface may include a modem and a local area network (LAN) interface. The modem and LAN interface may connect to external communication devices, such as mobile phone, computer system and laptops etc. via internet, WAN or other communication modes.

The memory module may be configured to store software used by the system such as an operating system, applications program and associated database. The memory module may further be configured to store instructions, executable by the processing module, for enabling the system to perform various functions.

The system may also include an input-output interface which may include, but not limited to, an interface for display, keyboard, mouse, keypad, speaker, haptic device, microphone, camera or other input-output techniques well known in the art.

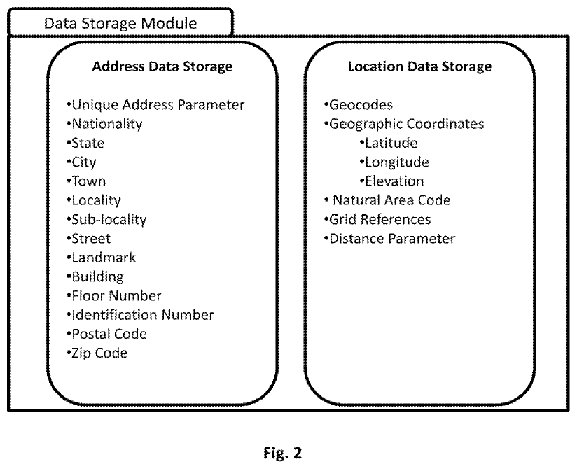

Referring the FIG. 2, there is shown a data storage module according to some embodiments of the present invention. The data storage module may be configured to store address data corresponding to an address of an entity. The address data may include nationality, state, city, town, locality, sub-locality, street, landmark, building, floor number, identification number, postal code, zip code or any other address identifying parameter.

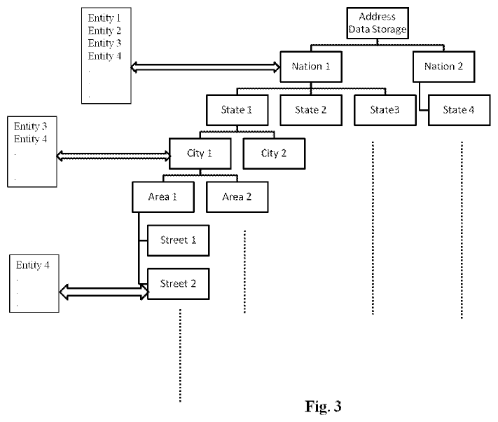

In an embodiment of the present invention, the storage of address data of entities in the data storage module may be implemented in form of a directed acyclic graph. Referring to FIG. 3, the directed acyclic graph corresponding to address data stored in the data storage module is shown. The graph may include a plurality of hierarchical addressing blocks corresponding to at least one of: nationality, state, city, town, locality, sub-locality, street, landmark, building, floor number, identification number, postal code, zip code or any other address identifying parameter well known in the art. A first addressing block may be connected to at least one second addressing block via a parent-child relationship.

Each hierarchical addressing block may link to one or more entities whose address data map on to the hierarchical addressing block. Hence, the hierarchical addressing block named ‘Delhi’ shall list all the entities which have ‘Delhi’ as city in their address data. Similarly, the hierarchical addressing block named ‘Janpath’ shall list all the entities which have ‘Janpath’ as street name in their address data.

In an embodiment of the present invention, the data storage module, as shown in FIG. 2, may further be configured to store a unique address parameter corresponding to at least one address of at least one entity. The unique address parameter identifies an entity based on at least one address of the entity. An entity may have more than one address, which may occur due to a number of reasons. As an example, different persons may write the same address differently. In an instance, while writing an address, one person may include landmark details while the other does not or there may be spelling differences, intentional or unintentional. This induces complexity and the uniqueness of the address is lost or diminished.

Hence, the unique address parameter corresponds to at least one such address of an entity. In one embodiment of the present invention, the system may be able to identify two different addresses as belonging to the same entity. In such a case, the unique address parameter may correspond to more than one address of the same entity, as will be shown in greater detail later.

The data storage module may also be configured to store location data corresponding to an entity. The location data may include geocodes, geographic coordinates such as latitude, longitude or elevation, natural area code, grid references, or the like. The location data may further include a distance parameter. The distance parameter along with geographical co-ordinates reflects a probabilistic area, with centre as the geographical co-ordinate and the radius as the distance parameter, which contains the exact location of the entity. Hence, the distance parameter is reflective of the error in the knowledge of location of the entity. Therefore, a larger distance parameter translates to a larger radius, which is interpreted as less preciseness in identifying the location of the entity.

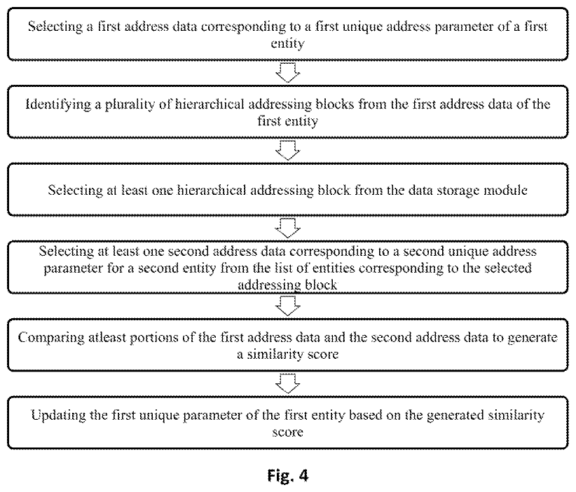

Referring now to FIG. 4, there is shown a unique address parameter system, according to one embodiment of the present invention.

A first unique address parameter of a first entity is selected by the processing module in accordance with the instructions stored in the memory module. The unique address parameter of the first entity may be allotted by the processing module according to an address data received by the processing module from a remote communication device (not shown) in real time or it may be pre-stored in data storage module. The processing module selects a first address data corresponding to the first unique address parameter.

Consider the following first address data for the first entity:

HN-2134, ABC Enclave, PQR Colony, Sector 91, Gurgaon 122505, Haryana

The processing module may identify a plurality of hierarchical addressing blocks from the first address data of the first entity. The hierarchical addressing blocks may typically be: Country1, State1, City1, Locality1, Sub-Locality1, Street1, Building1, House-Number1 and so on.

The identification of plurality of hierarchical addressing block may be performed using data processing techniques such as, but not limited to, machine learning, artificial intelligence, fuzzy learning, pattern matching or other techniques known in the art.

Hence, in the above example, the following hierarchical addressing blocks can be identified from the address data:

State: Haryana

City: Gurgaon

Locality: Sector 91

Sub-Locality: PQR Colony

Building: ABC Enclave

House Number: 2134

The processing module may select at least one addressing block from the list of the addressing blocks stored as the directed acyclic graph in the data storage module. The processing module may select the addressing block based on the plurality of addressing blocks identified from the address data of the first entity. Hence, the processing module may select the addressing block corresponding to City 1, or Locality 1 or Building 1 and so on. The processor may select the addressing block based on rules such as, but not limited to, addressing block having lower hierarchy in the directed acyclic graph, addressing block having linkage to maximum number of entities or having linkage to maximum number of entities whose distance parameters are lower than a threshold limit or any combination thereof. The processor may also select the addressing block randomly.

Hence, in the continuing example, the following addressing block can be selected:

Sub-Locality: PQR Colony

The processing module may be instructed to select at least one second unique address parameter for a second entity corresponding to the addressing block selected by the processing module. The second entity may be selected randomly, or based on rules such as, but not limited to, entity having distance parameter lower than a threshold limit, entity which may serve as a landmark (a monument or the like) or any combination thereof. The second entity may also be selected randomly. The processing module selects a second address data corresponding to the second unique address parameter.

In continuation with the above example, the processing module selects one second entity from the list of entities whose address data incorporate the hierarchical addressing block as Sub-Locality: PQR Colony. Hence, a second entity may be chosen which has the following address data:

#325, DEF Society, JKL Street, PQR Colony, Sec-91, Gurgaon

The processing module may compare at least portions of the first address data and the second address data and generate a similarity score between the two address data. To compare the address data, the processing module may convert the second address data into a second set of hierarchical addressing blocks. The processing module may select the complete address data for any of the first and second address data for comparison. Preferably, the processing module selects limited portions of the first and second address data. More preferably, the processing module selects only those portions of the first and second address data which are lower in hierarchy than the addressing block selected above.

In the above example, the processing module converts the address data of the second entity into the following hierarchical addressing blocks:

City: Gurgaon

Locality: Sector 91

Sub-Locality: PQR Colony

Street Name: JKL Street

Building: DEF Society

House Number: 325

Now, given that the selected hierarchical addressing blocks was Sub-Locality: PQR Colony, the processing module selects only those hierarchical addressing blocks of the first and second address data which are lower in hierarchy from the selected hierarchical addressing block.

Hence, the processing module may select the following portions of the first and second address data for comparison:

for first address data: HN-2134, ABC Enclave

for second address data: #325, DEF Society, JKL Street

The processing module may, then, generate a similarity score based on the comparison between the first and the second address data. The processing module may employ string comparison techniques, such as string metric, fuzzy searching, phonetic comparison, concept searching, semantic searching or other techniques well known in the art. The similarity score reflects the similarity between the selected portions of the first and second address data. Hence, if the two address portions are very similar to each other, for example only differing in house numbers, then the similarity score between the two is higher.

The processing module updates the first unique address parameter based on the generated similarity score. If the generated similarity score is above a threshold value, then it may be adjudged that the first address data and the second address data are same. In such a case, the processing module may update the first unique address parameter to be same as the second unique address parameter. If the generated similarity score is below a threshold value, the processing module may update the first unique address parameter to be different from the second unique address parameter.

The processing module may repeat the above procedure by selecting a third entity, a fourth entity, and so on.

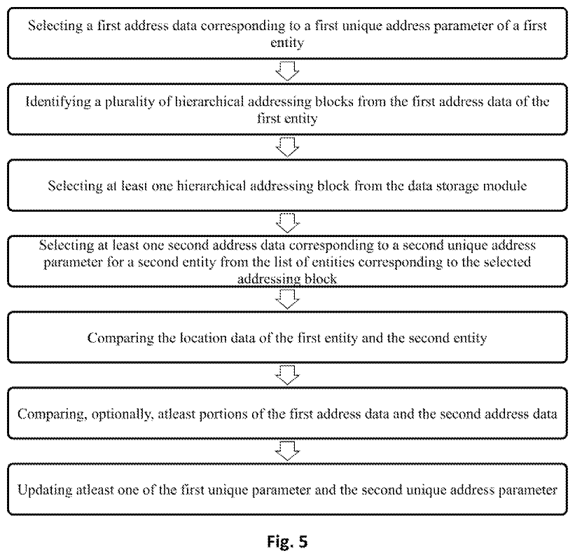

In an another embodiment of the present invention, the processing module may also compare the location data of the first and the second entity. The processing module may select the location data corresponding to the first and second unique address parameters. Referring to FIG. 5, the processing module may compare the geographical co-ordinates and the distance parameters for both unique address parameters with each other to find an overlap parameter value which reflects the degree of overlap between the two locations.

In an embodiment of the invention, the processing module may render a terrestrial map of at least a portion of the geographical area corresponding to at least one of the first location data and the second location data. The map may be generated by the processor in real time, or it may be stored in the data storage module, remote repository or the like. The map data may also be received by the processing module from external sources such as Google Maps, Open Street Maps or other third party services. The processing module may overlay the location data of the first entity and the location data of the second entity on the rendered map. The processing module may then calculate the overlap parameter value between the first location data and the second location data.

If the degree of overlap is very high, the processing module may identify both unique address parameters to be corresponding to the same entity.

In case the degree of overlap is below a threshold, the processing module may additionally compare at least portions of address data corresponding to the first and the second entity. The processing module may employ string comparison techniques, such as string metric, fuzzy searching, phonetic comparison, concept searching, semantic searching or other techniques well known in the art. Based on such address data comparison and the comparison of the location data, the processing module may identify both unique address parameters to be corresponding to the same entity. In such a case, the first and the second unique address parameter are merged to form a single unique address parameter. This reduces redundancy in the system and keeps the database optimized over time. Hence, here a single unique address corresponding to one entity may correspond to more than one address data of the one entity.

The disclosure is operational with numerous other general purpose or special purpose computing system environments or configurations. Examples of well known computing systems, environments, and/or configurations that may be suitable for use with the disclosure include, but are not limited to, personal computers, server computers, handheld or laptop devices, multiprocessor systems, microprocessor-based systems, set top boxes, programmable consumer electronics, network PCs, minicomputers, mainframe computers, and distributed computing environments that include any of the above systems or devices, and the like.

As used herein, the wording “entity” means any geographical area which may include, but not limited to, buildings, structures, monuments, open areas such as parks, grounds, forests.

1. A system comprising:
one or more processing modules;
one or more data storage modules, operatively coupled to the one or more processing modules, wherein the one or more data storage modules are configured to store at least one of:
a unique address parameter corresponding to at least one address of at least one facility;
an address data corresponding to an address of at least one facility; and
a location data corresponding to a location of at least one facility, wherein the location data comprises:
a geographical co-ordinate; and
a distance parameter;
at least one memory module operatively coupled to the one or more processing modules, wherein the at least one memory module stores instructions which, when executed by the one or more processing modules, causes the one or more processing modules to,
select, from the one or more data storage modules, a first unique address parameter corresponding to at least one address of a first facility and a second unique address parameter corresponding to at least one address of a second one facility;
select, from the one or more data storage modules, a first location data corresponding to a location of the first facility and a second location data corresponding to a location of the second facility;
compare the first location data and the second location data to generate an overlap parameter value; and
update at least one of the first unique address parameter and the second unique address parameter.

2. The system of claim 1, wherein the distance parameter is configured to reflect the location of the at least one facility to lie in a circle with center as the geographical co-ordinate and radius as the distance parameter.

3. The system of claim 1, wherein the one or more processing modules is further configured to merge the first and the second unique address parameter to form a single unique address parameter, if the overlap parameter value is above a first threshold.

4. The system of claim 1, wherein, in case the overlap parameter value is above a second threshold, the one or more processing modules is further instructed to:
select, from the one or more data storage modules, a first address data corresponding to an address of the first facility and a second address data corresponding to an address of the second facility;
compare at least portions of the first and second address data; and
update at least one of the first unique address parameter and the second unique address parameter.

5. The system of claim 4, wherein the one or more processing modules is further configured to convert the first address data into a first set of hierarchical addressing blocks and the second address data into a second set of hierarchical addressing blocks.

6. The system of claim 1, wherein the one or more processing modules further renders a terrestrial map of at least a portion of the geographical area corresponding to at least one of the first location data and the second location data.

7. A method for optimizing a unique address parameter database having a first unique address parameter corresponding to at least one address of a first facility and a second unique address parameter corresponding to at least one address of a second facility stored therein, the method comprising:
selecting a first location data corresponding to a location of the first facility and a second location data corresponding to a location of the second facility;
comparing the first location data and the second location data to generate an overlap parameter value; and
updating at least one of the first unique address parameter and the second unique address parameter.

8. The method of claim 7, wherein the method further comprises merging the first and the second unique address parameter to form a single unique address parameter, if the overlap parameter value is above a first threshold.

9. The method of claim 7, wherein, in case the overlap parameter value is above a second threshold, the method further comprises:
selecting a first address data corresponding to an address of the first facility and a second address data corresponding to an address of the second facility;
identifying a first portion of the first address data and a second portion of the section address data;
comparing the first portion and the second portion with each other; and
updating at least one of the first unique address parameter and the second unique address parameter.

10. The method of claim 9, wherein the method further comprises:
converting the first address data into a first set of hierarchical addressing blocks and the second address data into a second set of hierarchical addressing blocks; and
matching the first set of hierarchical addressing blocks with the second set of hierarchical addressing blocks to identify a first set of unmatched hierarchical addressing blocks and a second set of unmatched hierarchical addressing blocks.
